(19) United States
(12) Patent Application Publication
(10) Pub. No.: US 2024/0096275 A1
(43) Pub. Date: Mar. 21, 2024

(54) VARIABLE ELVDD WITH ADJACENT CODE CALIBRATION

(71) Applicant: APPLE INC., CUPERTINO, CA (US)

(72) Inventors: Shubham A. Gandhi, San Jose, CA (US); Jonathan H. Beck, San Francisco, CA (US); Koorosh Aflatooni, Los Altos Hills, CA (US); Mohammad Ali Jangda, Santa Clara, CA (US); Graeme M. Williams, San Diego, CA (US); Kingsuk Brahma, Mountain View, CA (US); Snehal T. Jariwala, San Jose, CA (US); Salman Kabir, Santa Clara, CA (US); Josiah Smith, CUPERTINO, CA (US)

(73) Assignee: APPLE INC., CUPERTINO, CA (US)

(21) Appl. No.: 17/933,457

(22) Filed: Sep. 19, 2022

(51) Int. Cl. G09G 3/3225; G09G 3/32; G09G 3/36

(52) U.S. Cl. CPC G09G 3/3225; G09G 3/32; G09G 3/3648; G09G 2320/0626; G09G 2320/0666; G09G 2320/0673; G09G 2320/0693; G09G 2330/021

(57) ABSTRACT

A electronic display device designed to calibrate brightness levels in a flat-panel display by using adjacent code calibration for a variable electroluminescence voltage supply in the flat-panel display.

### BACKGROUND

### Field

Aspects of the disclosure relate in general to flat-panel displays. Aspects include a method and device that calibrate brightness levels in a flat-panel display by using adjacent code calibration for a variable electroluminescence voltage supply in the flat-panel display.

### Description of the Related Art

Displays are electronic viewing technologies used to enable people to see content, such as still images, moving images, text, or other visual material.

A flat-panel display includes a display panel including a plurality of pixels arranged in a matrix format. The display panel includes a plurality of scan lines formed in a row direction (y-axis) and a plurality of data lines formed in a column direction (x-axis). The plurality of scan lines and the plurality of data lines are arranged to cross each other. Each pixel is driven by a scan signal and a data signal supplied from its corresponding scan line and data line.

Flat-panel displays can be classified as passive matrix type light emitting display devices or active matrix type light emitting display devices. Active matrix panels selectively light every unit pixel. Active matrix panels are used due to their resolution, contrast, and operation speed characteristics.

One type of active matrix display is an active matrix organic light emitting diode (AMOLED) display. The active matrix organic light emitting display produces an image by causing a current to flow to an organic light emitting diode to produce light. The organic light emitting diode is a light-emitting element in a pixel. The driving thin film transistor (TFT) of each pixel causes a current to flow in accordance with the gradation of image data.

Brightness of AMOLED display is directly proportional to the amount of current consumed. In other words, a larger emission current results in higher display brightness value (DBV). The emission current is directly proportional to pixel data voltage relative to the electroluminescence voltage supply (“ELVDD,” also referred to as a “pixel voltage supply”), Vdata-ELVDD.

Flat-panel displays are used in many portable devices such as laptops, mobile phones, smartphones, tablet computers, and other digital devices.

### SUMMARY

Embodiments include an electronic display designed to calibrate brightness levels in a flat-panel display by using adjacent code calibration for a variable electroluminescence voltage (ELDVDD) supply in the flat-panel display.

In one embodiment, an electronic apparatus comprises a display panel, a power management subsystem, and a display driver integrated circuit. The power management subsystem supplies a first ELVDD step voltage at a lower brightness of the display panel, and supply's a second ELVDD step voltage at a higher brightness of the display panel. A first ELVDD step voltage discontinuity exists between the first ELVDD step voltage and the second ELVDD step voltage. A display driver integrated circuit places at least two taps at each brightness level. The placing includes adding a first tap adjacent to the first ELVDD step discontinuity on the first ELVDD step, and adding a second tap adjacent to the first ELVDD step continuity on the second ELVDD step voltage. The display driver integrated circuit interpolates between taps on the at least two taps at each brightness level, and uses the interpolations to compensate for brightness or color temperature of the display panel.

In method embodiment, a power management subsystem supplies a variable electroluminescence voltage to a display panel. The variable ELVDD includes a first ELVDD step voltage at a lower brightness of the display panel, and a second ELVDD step voltage at a higher brightness of the display panel. A first ELVDD step voltage discontinuity exists between the first ELVDD step voltage and the second ELVDD step voltage. A display driver integrated circuit places at least two taps at each brightness level. The placing includes adding a first tap adjacent to the first ELVDD step discontinuity on the first ELVDD step, and adding a second tap adjacent to the first ELVDD step continuity on the second ELVDD step voltage. The display driver integrated circuit interpolates between taps on the at least two taps at each brightness level, and uses the interpolations to compensate for brightness or color temperature of the display panel.

In another embodiment, a non-transitory computer readable medium is encoded with data and instructions. The electronic apparatus executes the instructions causing the electronic apparatus to perform an electronic method. A power management subsystem supplies a variable electroluminescence voltage (ELVDD) to a display panel. The variable ELVDD includes a first ELVDD step voltage at a lower brightness of the display panel, and a second ELVDD step voltage at a higher brightness of the display panel. A first ELVDD step voltage discontinuity exists between the first ELVDD step voltage and the second ELVDD step voltage. A display driver integrated circuit places at least two taps at each brightness level. The placing includes adding a first tap adjacent to the first ELVDD step discontinuity on the first ELVDD step, and adding a second tap adjacent to the first ELVDD step continuity on the second ELVDD step voltage. The display driver integrated circuit interpolates between taps on the at least two taps at each brightness level, and uses the interpolations to compensate for brightness or color temperature of the display panel.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1A illustrates display luminescence of a flat-panel display is against the display brightness value with a fixed electroluminescence voltage.

FIG. 1B depicts display luminescence of a flat-panel display is against the display brightness value through increased electroluminescence voltage steps to provide greater driving range.

FIG. 2 depicts interpolation error that results in which Vdata interpolation is performed between tap points when there is a large fixed change in electroluminescence voltage.

FIG. 3 is a block diagram of a flat-panel display configured to calibrate brightness levels by using adjacent code calibration for an electroluminescence voltage supply in the display.

FIG. 4 depicts display luminescence of a flat-panel display is against the display brightness value through increased electroluminescence voltage steps to provide greater driving range using adjacent code calibration.

### DETAILED DESCRIPTION

Aspects of the disclosure include the observation that the voltage of the electroluminescence voltage supply, Vdata-ELVDD or “ELVDD”, provides the biggest impact in display brightness.

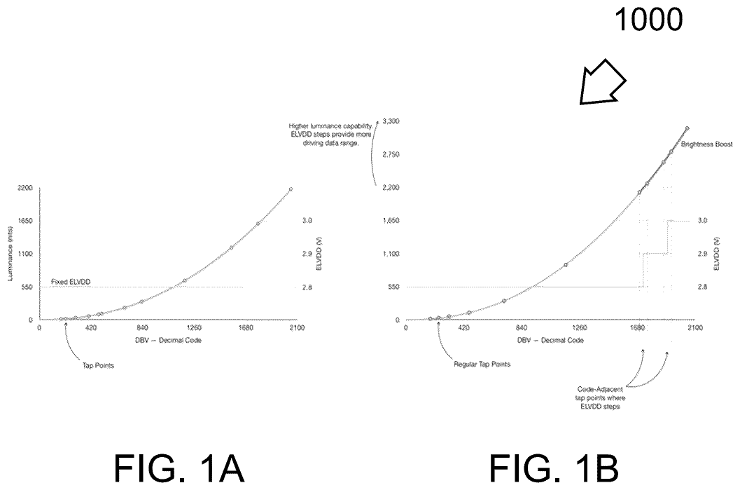

FIG. 1A illustrates display luminescence of a flat-panel display is against the display brightness value with a fixed electroluminescence voltage, constructed and operative in accordance with a present embodiment of the disclosure. As shown in FIG. 1A, display luminescence (measured in cd/m 2 or “nits”) is plotted against the display brightness value (“DBV,” measured in decimal code), with a fixed electroluminescence voltage (measured in voltage), showing different display operating points (“tap points”) at various brightness values and DBV. Tap points at DBV codes correspond to calibrated luminance output, where Vdata is tuned by measurement.

The curve depicts interpolated DBV codes at which pixel voltages (such as Vdata and ELVDD) are interpolated between tap points. The curve is calculated such that luminance vs DBV follows a gamma=2.2 curve anchored by calibrated tap points. Furthermore, ELVDD is the reference voltage against which Vdata interpolation is performed in between tap points. If there is any large, fixed change in this reference, a display driver integrated circuit (DDIC) has to compensate for the resulting error in brightness and color (white point). Due to unit-to-unit variation, the loss of calibration is not necessarily predictable, but some level of predictability may be possible at reduced accuracy.

ELVDD is an OLED display's positive emission power supply, as well as the fixed reference against which calibration is performed. Embodiments of the disclosure offer higher luminance capability through increased electroluminescence voltage steps to provide greater driving range, as shown in FIG. 1B, constructed and operative in accordance with a present embodiment of the disclosure. The implementation of gamma architecture and calibration methodology maintains a constant ELVDD voltage over the entire range of digital dimming and calibrated brightness levels. In this example, ELVDD is 2.8V. However, the disclosure uses a variable ELVDD reference voltage to achieve higher peak luminance while minimizing the static power cost incurred at lower luminance. A fixed reference in a typical calibration architecture places an upper bound on the data range used to drive a pixel, but having the capability to vary ELVDD, shown as 2.9V and 3.0V, respectively, allows a variable increase in data range when needed for pixels to achieve higher luminance output. Although two increases in ELVDD are shown in FIG. 1B, it is understood by one skilled in the art, that any number of increases may be used to enable higher capability in special high brightness modes.

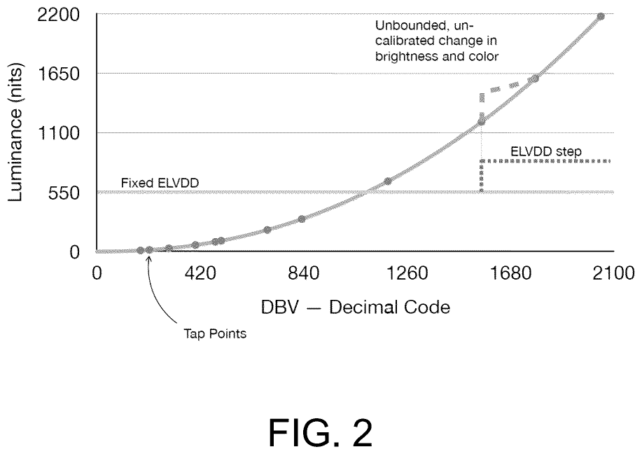

An increase in the ELVDD has consequences when interpolating between tap points, as shown in FIG. 2, constructed and operative in accordance with a present embodiment of the disclosure. When there is a large fixed change in ELVDD, a display driver integrated circuit (DDIC) cannot compensate for the resulting error in brightness and color temperature (“white point”). As shown in FIG. 2, the interpolation error between tap points causes discontinuity in brightness dimming smoothness. More importantly, due to unit-to-unit variation, the loss of calibration is not necessarily predictable, although some level of predictability may be possible at reduced accuracy.

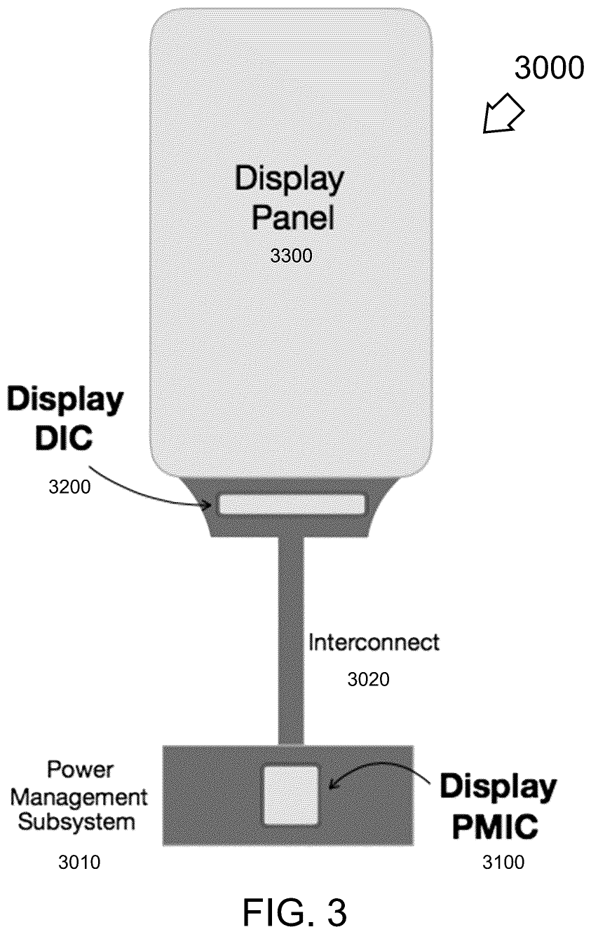

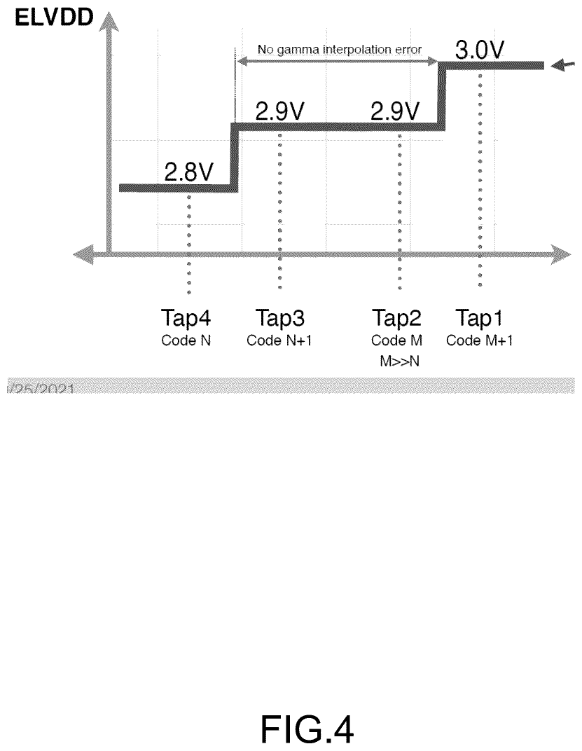

In order to better appreciate the features and aspects of the present disclosure, further context for the disclosure is provided in the following section by discussing an implementation of a flat-panel display that addresses a voltage increase by an electroluminescence voltage supply according to embodiments of the disclosure, as described in FIG. 3 and FIG. 4. FIG. 3 depicts an implementation of a flat-panel display, while FIG. 4 illustrates display luminescence of the flat-panel display using a method to control display brightness value through increased electroluminescence voltage steps using adjacent code calibration to provide greater driving range, constructed and operative in accordance with a present embodiment of the disclosure.

These embodiments are for explanatory purposes only and other embodiments may be employed in other display devices. For example, embodiments of the disclosure can be used with any display device that compensates for electroluminescence voltage supply increases by using adjacent code calibration.

FIG. 3 is a block diagram of a flat-panel display 3000 configured to calibrate brightness levels by using adjacent code calibration for an electroluminescence voltage supply in the display. Flat-panel display 3000 comprises a display panel 3300, a power management subsystem 3010, and a display driver integrated circuit (DDIC) 3200. These components are connected via interconnect 3020, as is known in the art. It is further understood that flat-panel display 3000 may be embedded into a computer, tablet computer, mobile phone, digital watch, augmented reality headset or any other visual display device.

The display panel 3300 may be an organic light-emitting diode (OLED) display, such as a passive-matrix (PMOLED) or active-matrix (AMOLED). In other embodiments, the display panel 3300 may be a liquid crystal display (LCD) or micro-light emitting diode (micro-LED) display. The display panel 3300 displays an image based upon the pixel display voltage and is powered by an electroluminescence voltage. The pixel display voltage is received from the display driver integrated circuit (DDIC) 3200, and the power management integrated circuit 3100 supplies the electroluminescence voltage, ELVDD.

The power management subsystem 3010 is configured to supply an electroluminescence voltage to the display panel 3300, and may perform electronic power conversion (such as variable voltage scaling) and/or power control functions. The power management subsystem 3010 may be implemented as a power management integrated circuit (PMIC) 3100 configured to enable a variable ELVDD reference voltage to achieve higher peak luminance while minimizing the static power cost incurred at lower luminance.

In some embodiments when display panel 3300 is current driven, such as an OLED display, the power management integrated circuit 3100 may drive the current through a gate of a Metal Oxide Semiconductor (MOS) transistor. In such an embodiment, each pixel of the display panel 3300 may be equipped with a MOS transistor (field effect transistor) with a switching function.

The display driver integrated circuit (DDIC) 3200 is a semiconductor integrated circuit that provides an interface function between the display panel 3300 and a microprocessor, microcontroller, application specific integrated circuit or other general-purpose peripheral interface (not shown). In some embodiments, the display driver integrated circuit 3200 may alternatively comprise a state machine made of discrete logic and other components.

The display driver integrated circuit 3200 may incorporate Random Access Memory (RAM), flash memory, Electrically Erasable Programmable Read-Only Memory (EEPROM) and/or Read-Only Memory (ROM) (not shown). In some embodiments, display driver integrated circuit 3200 may include a frame buffer.

As shown in FIG. 4, adjacent code calibration method employed by the power management subsystem 3010 maintains a constant ELVDD voltage of 2.8V over the entire range of digital dimming and calibrated brightness levels. The method uses a variable ELVDD reference voltage as a method of achieving higher peak luminance while minimizing the static power cost incurred at lower luminance. A fixed reference in a typical calibration architecture places an upper bound on the data range used to drive a pixel, but having the capability to vary ELVDD allows a variable increase in data range when needed for pixels to achieve higher luminance output, shown in this example with a ELVDD of 2.9V.

Variable ELVDD features implemented in the display driver integrated circuit 3300 allows for a settable ELVDD at each calibrated brightness tap, similar to other pixel and emission voltages. Adjacent code calibration is a technique that places two taps at each discontinuity or step in the ELVDD-vs-DBV profile as a way to get around the interpolation error resulting from a single tap. It is understood that some embodiments may have more than two taps at each discontinuity or step in the ELVDD. Having at least two taps at each discontinuity or step in the ELVDD allows the display driver integrated circuit 3300 to smooth over any discontinuity in brightness dimming smoothness. The taps are place adjacent to the discontinuity on each side of the discontinuity. The display driver integrated circuit 3300 then interpolates between taps on at least two taps at each brightness level, and uses the interpolations to compensate for brightness or color temperature of the display panel.

Some embodiments of a flat-panel display 3000 have a tuning knob, button, switch or other display brightness adjustment that sets emission current or ELVDD.

In this embodiment, the display driver integrated circuit 3300 includes the capability to sequence adjustments in power supplies and reference voltages of the power management subsystem 3010 such that the voltages meet slew rate requirements and settle within display blanking. In such an embodiment, a look-up-tables (LUTs) (not shown) may be used to program ELVDD vs. DBV settings. The display power management integrated circuit 3100 also has slew rate and timing requirements to enable adjustment of power supplies within flat-panel display 3000.

One alternate embodiment, which may be concurrently implemented with the above method, flat-panel display 3000 may allow further reduction of static power at lower luminance levels by introducing step-downs in the ELVDD profile where smaller data range is required.

Another alternate embodiment, flat-panel display 3000 predicts or calculates voltage settings and gamma digital-to-analog codes for a given ELVDD step based on the voltage step size and compensation factors derived from panel characterization.

It is understood by those familiar with the art that the system described herein may be implemented in a variety of hardware or firmware solutions. It is understood by any person skill in the art that the methods described herein may be executed by a computer encoded with instructions encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

1. An electronic apparatus comprising:
a display panel;
a power management subsystem configured to supply a variable electroluminescence voltage (ELVDD) to the display panel, the power management subsystem configured to supply a first ELVDD step voltage at a lower brightness level of the display panel, configured to supply a second ELVDD step voltage at a higher brightness level of the display panel, wherein a first ELVDD step voltage discontinuity exists between the first ELVDD step voltage and the second ELVDD step voltage;
a display driver integrated circuit configured to place at least two taps at each brightness level, the placing including:
adding a first tap adjacent to the first ELVDD step discontinuity on the first ELVDD step,
adding a second tap adjacent to the first ELVDD step continuity on the second ELVDD step voltage;
the display driver integrated circuit is further configured to:
interpolate between taps on the at least two taps at each brightness level, and
use the interpolations to compensate for brightness or color temperature of the display panel.

2. The electronic apparatus of claim 1,
wherein the power management system is further configured to supply a third ELVDD step voltage at a third brightness level of the display panel,
wherein a second ELVDD step voltage discontinuity exists between the second ELVDD step voltage and the third ELVDD step voltage.

3. The electronic apparatus of claim 2, wherein the placing further includes:
adding a third tap adjacent to the second ELVDD step discontinuity on the second ELVDD step voltage;
adding a fourth tap adjacent to the second ELVDD step continuity on the third ELVDD step voltage.

4. The electronic apparatus of claim 1, wherein the display driver integrated circuit further comprises a look-up-table to interpolate between the taps on the same ELVDD step.

5. The electronic apparatus of claim 3, wherein the display driver integrated circuit further comprises a look-up-table to interpolate between the taps on the same ELVDD step.

6. The electronic apparatus of claim 4, wherein the display panel is a light-emitting diode (LED) or liquid crystal display (LCD) display.

7. The electronic apparatus of claim 4, wherein the display panel is an organic light-emitting diode (OLED) display.

8. A method of operating an electronic apparatus comprising:
supplying a variable electroluminescence voltage (ELVDD) to the display panel, the power management subsystem configured to supply a first ELVDD step voltage at a lower brightness level of the display panel, configured to supply a second ELVDD step voltage at a higher brightness level of the display panel, wherein a first ELVDD step voltage discontinuity exists between the first ELVDD step voltage and the second ELVDD step voltage;
placing at least two taps at each ELVDD step with a display driver integrated circuit, the placing including:
adding a first tap adjacent to the first ELVDD step discontinuity on the first ELVDD step,
adding a second tap adjacent to the first ELVDD step continuity on the second ELVDD step voltage;
interpolating between taps on the at least two taps at each brightness level, and
using the interpolations to compensate for brightness or color temperature of the display panel.

9. The electronic method of claim 8, further comprising:
supplying a third ELVDD step voltage at a third brightness level of the display panel with the power management system,
wherein a second ELVDD step voltage discontinuity exists between the second ELVDD step voltage and the third ELVDD step voltage.

10. The electronic method of claim 9, wherein the placing further includes:
adding a third tap adjacent to the second ELVDD step discontinuity on the second ELVDD step voltage;
adding a fourth tap adjacent to the second ELVDD step continuity on the third ELVDD step voltage.

11. The electronic method of claim 8, wherein the display driver integrated circuit further comprises a look-up-table to interpolate between the taps on the same ELVDD step.

12. The electronic method of claim 10, wherein the display driver integrated circuit further comprises a look-up-table to interpolate between the taps on the same ELVDD step.

13. The electronic method of claim 11, wherein the display panel is a light-emitting diode (LED) or liquid crystal display (LCD) display.

14. The electronic method of claim 11, wherein the display panel is an organic light-emitting diode (OLED) display.

15. A non-transitory computer readable medium encoded with data and instructions, when executed by electronic apparatus the instructions causing the electronic apparatus to:
supplying a variable electroluminescence voltage (ELVDD) to the display panel, the power management subsystem configured to supply a first ELVDD step voltage at a lower brightness level of the display panel, configured to supply a second ELVDD step voltage at a higher brightness level of the display panel, wherein a first ELVDD step voltage discontinuity exists between the first ELVDD step voltage and the second ELVDD step voltage;
place at least two taps at each ELVDD step with a display driver integrated circuit, the placing including:
adding a first tap adjacent to the first ELVDD step discontinuity on the first ELVDD step,
adding a second tap adjacent to the first ELVDD step continuity on the second ELVDD step voltage;
the display driver integrated circuit is further configured to:
interpolate between taps on the at least two taps at each brightness level, and
use the interpolations to compensate for brightness or color temperature of the display panel.

16. The non-transitory computer readable medium of claim 15, wherein the data instructions further cause the electronic apparatus to:
supplying a third ELVDD step voltage at a third brightness level of the display panel with the power management system,
wherein a second ELVDD step voltage discontinuity exists between the second ELVDD step voltage and the third ELVDD step voltage.

17. The non-transitory computer readable medium of claim 16, wherein the data instructions further cause the electronic apparatus to:
add a third tap adjacent to the second ELVDD step discontinuity on the second ELVDD step voltage;
add a fourth tap adjacent to the second ELVDD step continuity on the third ELVDD step voltage.

18. The non-transitory computer readable medium of claim 15, the display driver integrated circuit further comprises a look-up-table to interpolate between the taps on the same ELVDD step.

19. The non-transitory computer readable medium of claim 17, the display driver integrated circuit further comprises a look-up-table to interpolate between the taps on the same ELVDD step.

20. The non-transitory computer readable medium of claim 18, wherein the display panel is an organic light-emitting diode (OLED) display.
